(19) United States
(12) Patent Application Publication
(10) Pub. No.: US 2009/0084385 A1
(43) Pub. Date: Apr. 2, 2009

(54) Oxygen Face Mask With Incorporated Access

(76) Inventor: Eric Lang, McMinnville, TN (US)

Correspondence Address: ROBERT M. SCHWARTZ, P.A., P.O. BOX 221470, HOLLYWOOD, FL, 33022, US

(21) Appl. No.: 12/239,865

(22) Filed: Sep. 29, 2008

Related U.S. Application Data
(60) Provisional application No. 60/976,566, filed on Oct. 1, 2007.

(51) Int. Cl. A62B 18/02; A62B 18/08

(52) U.S. Cl. 128/206.21; 128/207.11

(57) ABSTRACT

The present invention is a multi-purpose oxygen face mask having a self-closable port, integral with the surface of said mask shell, configured to receive a tube or implement that passes through the mask shell and maintains delivery of oxygen.

### INDEX TO RELATED APPLICATIONS

This application claims the benefit of U.S. Provisional Application No. 60/976,566, filed Oct. 1, 2007, the disclosure of which is incorporated herein by reference in its entirety.

### BRIEF SUMMARY OF THE INVENTION

### In-Mask Valve

Thousands of patients with primarily respiratory diseases and disorders are admitted daily to hospitals in the USA. Often they require oxygen (O₂) via a face mask (FM). Disruption of the FM seal i.e., (1) to eat or (2) to drink, to (3) receive a feeding tube, to (4) undergo diagnostics procedures, for (5) suctioning/removal of secretions, and to (6) receive medications; occurs often throughout the day. These disruptions 'til now, are handled by removing the mask temporarily or temporarily switch to nasal O₂ and can precipitate drops in arterial O₂ with attendant risks to bodily functions.

An In-Mask valve, properly situated, would allow performance of all these tasks without disrupting the integrity of the mask. As a practicing pulmonary specialist, I know this idea is long overdue and will make patient care much more efficient.

In addition to patients having respiratory diseases, these masks are commonly employed by anesthesiologists, and surgeons on postoperative cases.

The present invention is a multi-purpose oxygen face mask comprising:

a mask shell;
a head strap connected to said mask shell at a point on a first side, and extending from said mask body around the rear of a patient's head and connects with said mask body at a second side; and
a self-closable access port, integral with the surface of said mask shell.

The port is configured to receive an implement that passes through the mask and maintains a substantially airtight seal.

The face mask maintains oxygen flow and volume at a substantially constant level upon insertion of an implement through the access port.

The access port is constructed and arranged to close about the perimeter of an implement inserted therethrough.

The present invention is a method for accessing the region of the face covered by an oxygen face mask comprising:
a. Providing a multi-purpose oxygen face mask comprising:
   a mask shell;
   a head strap connected to said mask shell at a point on a first side, and extending from said mask body around the rear of a patient's head and connects with said mask shell at a second side;
   a self-closable access port, integral with the surface of said mask;
   b. accessing the self closable access port;
   c. opening the self closable accessport by inserting, an implement therethrough;
   d. allowing the self closable access port to seal around the perimeter of said implement;
   e. accessing the face area under an oxygen face mask of a patient that is wearing said mask shell using an implement inserted through a self closable access port.

The implement is not limited, but in a preferred embodiment is a straw, feeding tube, solution tube, suction tube, and the like.

### BRIEF DESCRIPTION OF THE DRAWINGS

FIG. 1 is a front view of a prior art oxygen face mask mounted on a person.

FIG. 2 is a front view of the face mask of the present invention with a self closing access port incorporated into the mask.

FIG. 3 is a side view of the mask in section with an implement inserted therethrough.

FIG. 4 is a side view of the mask in section without an implement inserted therethrough.

FIG. 5 is a partial side view of the mask in section with an implement inserted therethrough.

FIG. 6 is a partial side sectional view of an oxygen face mask of the present invention with a self closing valve in the closed configuration.

FIG. 7 is a front view of the access port with an implement inserted therethrough.

FIG. 8 is a front view of the access port in a closed position.

FIG. 9 is a front view of the face mask of the present invention with a self closing access port incorporated into the mask.

FIG. 10 is a side view of the mask of FIG. 9 in section with an implement inserted therethrough.

FIG. 11 is a front view of the access port with an implement inserted therethrough.

### DETAILED DESCRIPTION OF THE PREFERRED EMBODIMENT

The mask 10 has a shell 12 with a pair of straps 14 positioned on either side of shell 12. Shell 12 has an oxygen tube 14 emanating therefrom that allows oxygen to flow into shell 12 as is commonly known in the art. Shell 12 has incorporated thereon access port 18. In one embodiment, access port 18 is formed of a first flap 20 and second flap 22 that interface to define a slit 24. An implement 28 is placed between first flap 20 and second flap 22 such that opening 26 is exposed.

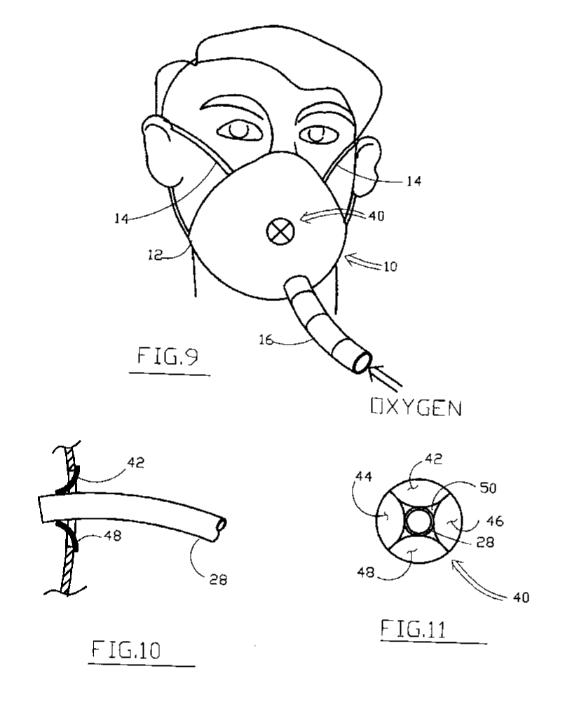

In another embodiment, as shown in FIGS. 9-11, access port 40 is circular and has flaps 42, 44, 46, and 48 that interface to form a plurality of slits along adjacent edges when closed. An implement 28 is centrally placed through access port 40 such that opening 50 is exposed.

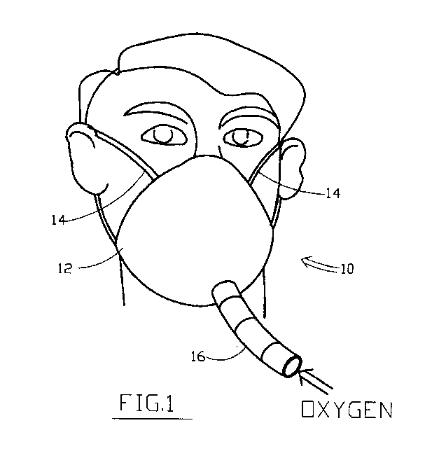

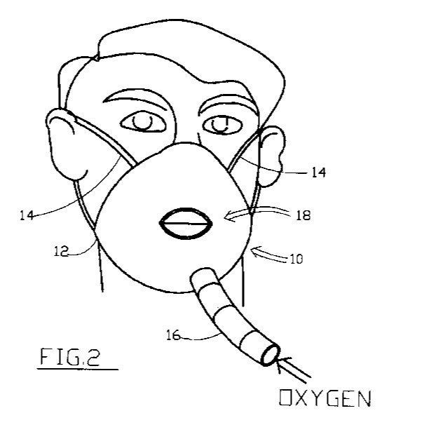

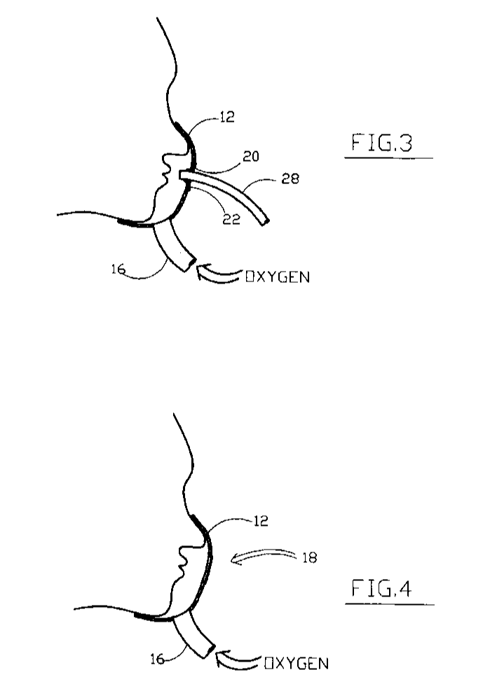

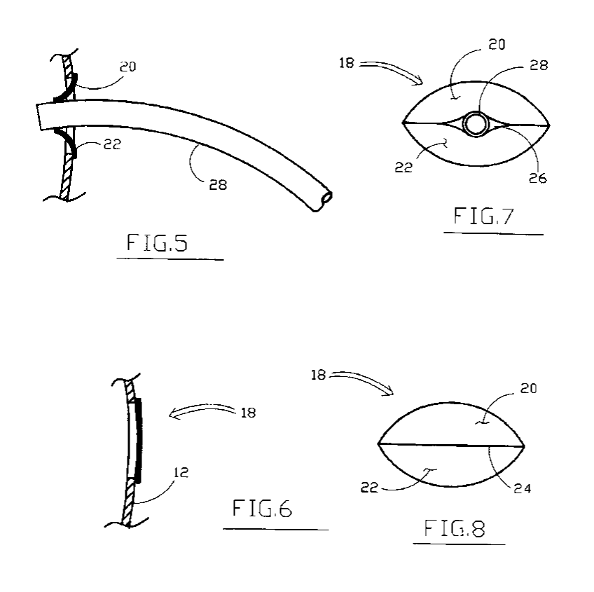

Shell 12 is placed over the nose and mouth of a person as is commonly known. Shell 12 is secured into position by placing each of side straps 14 behind the ear of a person as depicted in FIGS. 1 and 2 and is commonly known.

Shell 12, as is commonly known and used in the art, is constructed and arranged in the present invention with an access port 18. The access port 18 of the present invention is an incorporated opening integral with the surface of shell 12 that remains in a closed position were not used. Implement 28, which include, but are not limited to, a straw, feeding tube, solution tube, suction tube, and the like are insertable through access port 18 without interrupting the oxygen therapy.

The placement of the implement is described in terms of one embodiment. It is understood that the description is not limited and maybe applied to any configured embodiment. Implement 28 is placed along slit 24 is gently urged by pressure through access port 18 such that the access port 18 opens to form opening 26 that receives implement 28. Access port 18 subsequently seals around implement 28 after insertion such that substantially the entire perimeter of implement 28 is in contact with the edges of flaps forming access port 18 in order that there is minimal loss of oxygen flowing into shell 12. It is not necessary that an air tight seal be formed about the perimeter of implement 28, only that enough of a seal is present to prevent any significant loss of oxygen flowing into shell 12 from oxygen tube 16.

Access port 18 is a self-closing slit or opening within a circular or oval region constructed and arranged such that it remains closed when not in use, and will close around a an implement 28 inserted therethrough.

While the invention has been described in its preferred form or embodiment with some degree of particularity, it is understood that this description has been given only by way of example and that numerous changes in the details of construction, fabrication, and use, including the combination and arrangement of parts, may be made without departing from the spirit and scope of the invention.

I claim:

1. A multi-purpose oxygen face mask comprising:
a mask shell;
a head strap connected to said mask shell at a point on a first side, and extending from said mask body around the rear of a patient's head and connects with said mask body at a second side;
a self-closable access port, integral with the surface of said mask shell;
wherein said port is configured to receive an implement that passes through the mask and maintains a substantially airtight seal.

2. The face mask of claim 1 wherein oxygen flow and volume maintains a substantially constant level upon insertion of an implement through said access port.

3. The face mask of claim 1 wherein said access port is constructed and arranged to close about the perimeter of an implement inserted therethrough.

4. A method for accessing the region of the face covered by an oxygen face mask comprising:
a. Providing a multi-purpose oxygen face mask comprising:
a mask shell;
a head strap connected to said mask shell at a point on a first side, and extending from said mask body around the rear of a patient's head and connects with said mask shell at a second side;
a self-closable access port, integral with the surface of said mask;
b. accessing the self closable access port;
c. opening the self closable accessport by inserting, an implement therethrough;
d. allowing the self closable access port to seal around the perimeter of said implement;
e. accessing the face area under an oxygen face mask of a patient that is wearing said mask shell using an implement inserted through a self closable access port.

5. The method of claim 4 wherein said implement is a straw, feeding tube, solution tube, suction tube, and the like
